(19) United States
(12) Patent Application Publication
(10) Pub. No.: US 2011/0127180 A1
(43) Pub. Date: Jun. 2, 2011

(54) LOTTERY SCRATCH TICKET HOLDING DEVICE

(76) Inventor: David A. Vogias, Fort Myers, FL (US)

(21) Appl. No.: 12/626,703

(22) Filed: Nov. 27, 2009

(51) Int. Cl. B65D 69/00; B42D 17/00; B65D 85/00; A45C 11/18

(52) U.S. Cl. 206/232; 281/45; 206/459.5; 206/39

(57) ABSTRACT

A lottery scratch ticket holding device (1) having a board (2) with a front surface (3), a rear surface (4), a top portion (5) and a bottom portion (6). A clip (7) is located along the top portion of the board and used for attaching, holding and storing scratch tickets (9) and other lottery tickets on the holding device. A receptacle (8) is located across the bottom portion of the board. The receptacle is used to collect any scrapings created as a user scratches the opaque covering off a scratch ticket.

### BACKGROUND OF THE INVENTION

This invention relates lottery scratch tickets and more particularly, a holding device for holding and storing scratch tickets having a receptacle for collecting scrapings created by scratching an opaque covering off the surface of a scratch ticket.

Scratch tickets, which are also referred to as scratch cards and scratch offs, are a popular form of gambling especially in state-run lotteries. Scratch tickets are usually made of cardboard having one or more areas covered by an opaque covering, which is usually latex, that can be scratched off. When a lottery player scratches off the opaque covering, information such as numbers and prize amounts printed on the areas covered by the opaque covering are revealed. Simple scratch tickets require a player to match one or more numbers, symbols, pictures and/or words printed on the scratch ticket to win a prize amount. A problem many users encounter with using scratch tickets are the scrapings created by scratching off the opaque covering. The scrapings create a mess by either getting on a person's clothes or all over a person's car. An additional problem is that a solid surface is always needed in order for a user to be able to apply enough pressure to a scratch ticket to scratch off the opaque covering. An even further problem is that lottery players often misplace and/or loose lottery tickets because they do not have a place to hold and store the tickets.

Therefore, a need exists for a device which will hold and store scratch tickets and other lottery tickets, provide a solid surface for a user to scratch a scratch ticket against and provide a means for collecting the scrapings created by scratching the opaque covering off of the scratch ticket.

The relevant prior art includes the following references:

| Pat. No. | Inventor | Issue/Publication Date |
|---|---|---|
| (U.S. unless stated otherwise) | | |
| 2006/0278540 | Schacht | Dec. 14, 2006 |
| D392,783 | Eastman | Mar. 24, 1998 |
| 5,419,004 | Fox | May 30, 1995 |
| 5,367,959 | Allen et al. | Nov. 29, 1994 |
| 5,127,720 | Shultz | Jul. 07, 1992 |
| 4,907,823 | Windish | Mar. 13, 1990 |
| 4,881,291 | Ellis | Nov. 21, 1989 |
| 4,662,518 | Chiappetta et al. | May 05, 1987 |
| 4,646,382 | Smith | Mar. 03, 1987 |

### SUMMARY OF THE INVENTION

The primary object of the present invention is to provide a lottery scratch ticket holding device that will collect the scrapings created by scratching an opaque covering off of a scratch ticket.

Another object of the present invention is to provide a lottery scratch ticket holding device that will hold and store lottery tickets.

A further object of the present invention is to provide a lottery scratch ticket holding device that provides a solid surface for a user to scratch a scratch ticket against.

A further object of the present invention is to provide a lottery scratch ticket holding device that is compact and easy to store in an automobile in a glove box, center console, sun visor and so forth.

The present invention fulfills the above and other objects by providing a holding device having a board with a clip attached thereto. A user may attach a scratch ticket to the board using the clip. The board provides a backing so that the user may apply enough pressure to a scratch ticket when scratching an opaque covering off the ticket. A user may also use the clip to hold and store multiple scratch tickets and other lottery tickets on the board. In addition, a receptacle, located on the bottom portion of the holding device, collects any scrapings created as a user scratches the opaque covering off scratch tickets on the holding device.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a front view of a lottery scratch ticket holding device of the present invention;

FIG. 2 is a front perspective view of a lottery scratch ticket holding device of the present invention having a scratch ticket attached thereto;

FIG. 3 is a side view of a lottery scratch ticket holding device of the present invention; and

FIG. 4 is a side view of a lottery scratch ticket holding device of the present invention having a visor clip.

### DESCRIPTION OF THE PREFERRED EMBODIMENTS

For purposes of describing the preferred embodiment, the terminology used in reference to the numbered accessories in the drawings is as follows:
1. holding device
2. board
3. front surface
4. rear surface
5. top portion
6. bottom portion
7. clip
8. receptacle
9. scratch ticket
10. visor clip
11. advertising area
12. hole

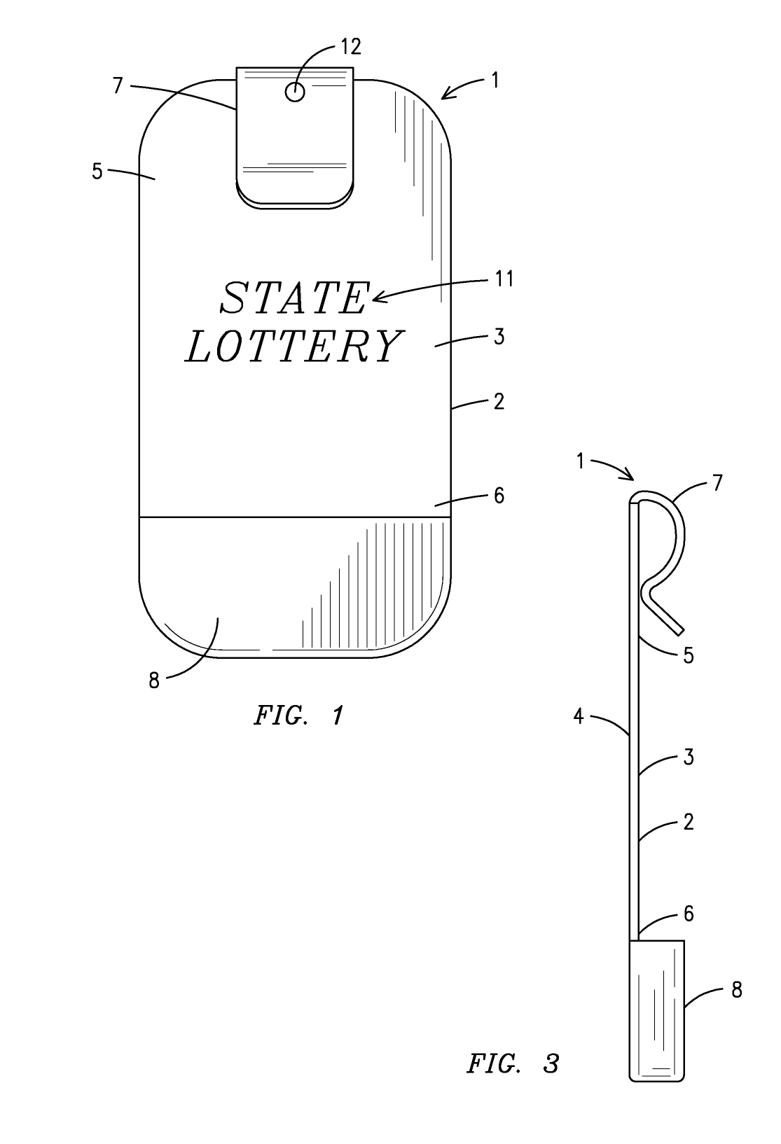

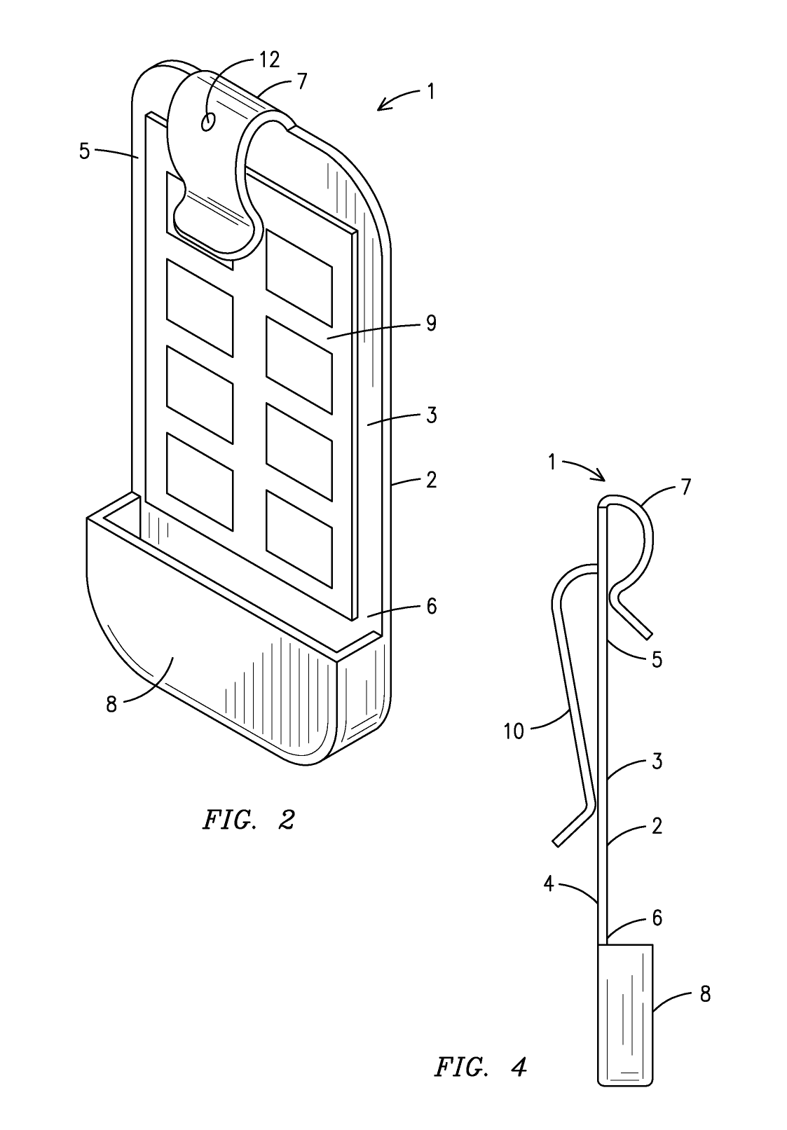

With reference to FIG. 1, a front view of a lottery scratch ticket holding device 1 of the present invention is shown. The holding device 1 comprises a flat substantially rectangular shaped board 2 having a front surface 3, a rear surface 4, a top portion 5 and a bottom portion 6. A clip 7 is located on the top portion 5 of the board 2 and used for attaching, holding and storing scratch tickets 9 and other lottery tickets on the holding device 1, as shown in FIG. 2. A receptacle 8 is located across the bottom portion 6 of the board 2. The receptacle 8 is used to collect any scrapings created as a user scratches the opaque covering off a scratch ticket 9. At least one advertising area 11 is located on the lottery scratch ticket holding device 1. Advertisements, such as a logos for a state lotteries, may be displayed in the advertising area 11. A hole 12 is located in the clip 7. The hole 12 may be used for hanging the lottery scratch ticket holding device 1 on a display, in the home and so forth.

Referring now to FIG. 2, a front perspective view of a lottery scratch ticket holding device 1 of the present invention having a scratch ticket 9 attached thereto is shown. The holding device 1 comprises a flat substantially rectangular shaped board 2 having a front surface 3, a rear surface 4, a top portion 5 and a bottom portion 6. A clip 7 is located on the top portion 5 of the board 2 and used for attaching, holding and storing scratch tickets 9 and other lottery tickets on the holding device 1. A receptacle 8 is located across the bottom portion 6 of the board 2 and used to collect any scrapings created as a user scratches the opaque covering off a scratch ticket 9.

Referring now to FIG. 3, a side view of a lottery scratch ticket holding device 1 of the present invention is shown. The holding device 1 comprises a flat substantially rectangular shaped board 2 having a front surface 3, a rear surface 4, a top portion 5 and a bottom portion 6. A clip 7 is located on the top portion 5 of the board 2 and used for attaching, holding and storing scratch tickets 9 and other lottery tickets on the holding device 1. A receptacle 8 is located across the bottom portion 6 of the board 2 and used to collect any scrapings created as a user scratches the opaque covering off a scratch ticket 9.

Referring now to FIG. 4, a side view of a lottery scratch ticket holding device 1 of the present invention having a visor clip 10 is shown. The visor clip 10 is located on a rear surface 4 of the holding device 1 and allows a user to store the holding device 1 on a sun visor in an automobile.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

1. A lottery scratch ticket holding device comprising:
a board having a front surface, a rear surface, a top portion, a bottom portion, an upper edge, a lower edge and side edges;
said front surface of top portion being flat and not having any raised portions;
a clip located on the front surface of the board;
said clip being located along the upper edge of the top portion of the board;
a receptacle being located on the front surface of the board;
said receptacle being located on the bottom portion of the board;
said receptacle being enclosed on a bottom by a bottom wall that extends outward from the front surface along the lower edge;
said receptacle being enclosed on two sides by side walls that extend said receptacle being enclosed on a front by a front wall that is substantially parallel to the front surface and located between the bottom wall and the
said receptacle having an opening located on top for catching scrapings within the hollow space of the receptacle.

2.-5. (canceled)

6. The lottery scratch ticket holding device of claim 1 further comprising:
a visor clip attached to the rear surface of the board.

7. The lottery scratch ticket holding device of claim 1 further comprising:
at least one advertising area on the board.

8. The lottery scratch ticket holding device of claim 1 further comprising:
a hole in the lottery scratch ticket holding device for hanging the lottery scratch ticket holding device.

9.-18. (canceled)

19. A lottery scratch ticket holding device comprising:
a board having a front surface, a rear surface, a top portion, a bottom portion, an upper edge, a lower edge and side edges;
said front surface of top portion being flat and not having any raised portions;
a clip located on the front surface of the board;
said clip being located along the upper edge of the top portion of the board;
a receptacle being located on the front surface of the board;
said receptacle being located on the bottom portion of the board;
said receptacle being enclosed on a bottom by a bottom wall that extends outward from the front surface along the lower edge;
said receptacle being enclosed on two sides by side walls that extend said receptacle being enclosed on a front by a front wall that is substantially parallel to the front surface and located between the bottom wall and the
said receptacle having an opening located on top for catching scrapings within the hollow space of the receptacle; and
a visor clip attached to the rear surface of the board.

20. The lottery scratch ticket holding device of claim 19 further comprising:
at least one advertising area on the board.

21. The lottery scratch ticket holding device of claim 19 further comprising:
a hole in the lottery scratch ticket holding device for hanging the lottery scratch ticket holding device.

22. A lottery scratch ticket holding device consisting of:
a board having a front surface, a rear surface, a top portion, a bottom portion, an upper edge, a lower edge and side edges;
said front surface of top portion being flat and not having any raised portions;
a clip located on the front surface of the board;
said clip being located along the upper edge of the top portion of the board;
a receptacle being located on the front surface of the board;
said receptacle being located on the bottom portion of the board;
said receptacle being enclosed on a bottom by a bottom wall that extends outward from the front surface along the lower edge;
said receptacle being enclosed on two sides by side walls that extend said receptacle being enclosed on a front by a front wall that is substantially parallel to the front surface and located between the bottom wall and the
said receptacle having an opening located on top for catching scrapings within the hollow space of the receptacle; and
a visor clip attached to the rear surface of the board.

23. The lottery scratch ticket holding device of claim 22 further comprising:
at least one advertising area on the board.

24. The lottery scratch ticket holding device of claim 22 further comprising:
a hole in the lottery scratch ticket holding device for hanging the lottery scratch ticket holding device.
